(19) United States
(12) Patent Application Publication
(10) Pub. No.: US 2024/0104723 A1
(43) Pub. Date: Mar. 28, 2024

(54) APPARATUS AND METHOD FOR MEASURING SOLUBILITY

(71) Applicant: SAMSUNG ELECTRONICS CO., LTD., Suwon-si (KR)

(72) Inventors: Gahee KIM, Suwon-si (KR); Joon-Kee CHO, Suwon-si (KR); Hyun Do CHOI, Suwon-si (KR); Younsuk CHOI, Suwon-si (KR); Jeonghun KIM, Suwon-si (KR); Sooyoung PARK, Suwon-si (KR)

(73) Assignee: SAMSUNG ELECTRONICS CO., LTD., Suwon-si (KR)

(21) Appl. No.: 18/112,927

(22) Filed: Feb. 22, 2023

(30) Foreign Application Priority Data
Sep. 26, 2022 (KR) 10-2022-0121740

(51) Int. Cl. G06T 7/00; G06V 10/25; G06V 10/28; G06V 10/62

(52) U.S. Cl. CPC G06T 7/0012; G06V 10/25; G06V 10/28; G06V 10/62

(57) ABSTRACT

An apparatus for measuring solubility includes: a display configured to display at least one patterned background image; an image obtaining sensor configured to obtain at least one transmission image formed by light from the at least one patterned background image being transmitted through a container accommodating a target sample, of which solubility is to be measured; and a processor configured to analyze a degree of dissolution of the target sample from the at least one transmission image based on at least one analysis algorithm.

### CROSS-REFERENCE TO RELATED APPLICATION

This application claims priority from Korean Patent Application No. 10-2022-0121740, filed on Sep. 26, 2022, in the Korean Intellectual Property Office, the disclosure of which is incorporated by reference herein in its entirety.

### BACKGROUND

### 1. Field

Methods and apparatuses consistent with embodiments relate to an apparatus and method for measuring solubility.

### 2. Description of Related Art

Methods for measuring solubility include, for example, a method of measuring an optical density using a spectrophotometer, or a method of measuring turbidity using a nephelometer or a turbidimeter. Both of the traditional measurement methods described above utilize light scattering, which may not measure the solubility in real time and may merely correspond to a measure of a degree of dissolution of a solute in a solution, rather than a direct sensing the solubility. In addition, the measurement methods described above measure values relative to a reference sample and provide digitized data, and thus a data processing process is required.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an example embodiment, an apparatus for measuring solubility, the apparatus may include: a display configured to display at least one patterned background image; a camera configured to obtain at least one transmission image formed by light from the at least one patterned background image being transmitted through a container accommodating a target sample, of which solubility is to be measured; and a processor configured to analyze a degree of dissolution of the target sample from the at least one transmission image based on using at least one analysis algorithm.

The processor may be further configured to use the at least one analysis algorithm to determine, from the at least one transmission image, at least one of: whether the target sample is completely dissolved, opacity of a solution in which the target sample is dissolved, whether undissolved particles are present in the solution in which the target sample is dissolved, or whether residues are present around the container.

The processor may be further configured to: analyze the degree of dissolution of the target sample from the at least one transmission image by using a different analysis algorithm of the at least one analysis algorithm for each patterned background image of the at least one patterned background image corresponding to the at least one transmission image.

The processor may be further configured to: analyze the degree of dissolution of the target sample from the at least one transmission image or a combination of the at least one transmission image by using a neural network trained based on the at least one analysis algorithm.

The processor may be further configured to: extract features from the at least one transmission image; analyze the degree of dissolution of the target sample as being one of a completely dissolved state, a supersaturated state, or a turbid state based on the extracted features; and generate a control signal based on a result of the analyzing the degree of dissolution of the target sample.

The processor may be further configured to: extract a region of interest (ROI) from the at least one transmission image; and extract the features by applying, to the ROI, a different analysis algorithm of the at least one analysis algorithm for each patterned background image of the at least one patterned background image corresponding to the at least one transmission image.

The at least one patterned background image may include at least one of a checker pattern image, a white image, or a radial pattern image. The at least one analysis algorithm may include: a first analysis algorithm corresponding to the white image, the first analysis algorithm comprising a (1-1)-th analysis algorithm configured to analyze the degree of dissolution of the target sample based on uniformity in a grid corresponding to the ROI, a (1-2)-th analysis algorithm configured to analyze the degree of dissolution of the target sample based on a change in brightness and a change in curvature in a region corresponding to pixels of an image sensor corresponding to the ROI, and a (1-3)-th analysis algorithm configured to analyze the degree of dissolution of the target sample based on a number of particles included in the ROI; and a second analysis algorithm corresponding to the checker patterned image, the second analysis algorithm comprising a (2-1)-th analysis algorithm configured to analyze the degree of dissolution of the target sample by an edge detected based on a gradient obtained from the ROI, a (2-2)-th analysis algorithm configured to analyze the degree of dissolution of the target sample by an attribute value of a straight line detected from a binarized image corresponding to the ROI, and a (2-3)-th analysis algorithm configured to analyze the degree of dissolution of the target sample by narrowing an interval between the ROIs and removing a background pixel.

The processor may be further configured to: based on the result of the analyzing indicating success, generate a control signal for proceeding with a reaction of a next operation; and based on the result of the analyzing indicating failure, generate a control signal for adding a solvent, adjusting a temperature, adjusting an agitation speed, or increasing reaction time.

The processor may be further configured to: determine the at least one patterned background image based on a result of the analyzing the degree of dissolution of the target sample; and control the display to display the determined at least one patterned background image.

The target sample may include at least one of a solid sample or a liquid sample.

The apparatus may further include a driver configured to fix or move the container according to a control signal from the processor. The camera may be further configured to repeatedly capture the at least one transmission image over a period of time.

According to an aspect of an example embodiment, a method of measuring solubility may include: displaying at least one patterned background image according to a control signal; obtaining at least one transmission image formed by light from the at least one patterned background image being transmitted through a container accommodating a target sample, of which solubility is to be measured; and analyzing a degree of dissolution of the target sample from the at least one transmission image based on at least one analysis algorithm.

The at least one analysis algorithm may be configured to determine, from the at least one transmission image, at least one of: whether the target sample is completely dissolved, opacity of a solution in which the target sample is dissolved, whether undissolved particles are present in the solution in which the target sample is dissolved, or whether residues are present around the container.

The analyzing the degree of dissolution of the target sample may include: analyzing the degree of dissolution of the target sample from the at least one transmission image by using a different analysis algorithm of the at least one analysis algorithm for each patterned background image of the at least one patterned background image corresponding to the at least one transmission image.

The analyzing the degree of dissolution of the target sample may include: analyzing the degree of dissolution of the target sample from the at least one transmission image or a combination of the at least one transmission image by using a neural network trained based on the at least one analysis algorithm.

The analyzing the degree of dissolution of the target sample may include: extracting a region of interest (ROI) from the at least one transmission image; extracting features by applying, to the ROI, a different analysis algorithm of the at least one analysis algorithm for each patterned background image of the at least one patterned background image corresponding to the at least one transmission image; analyzing the degree of dissolution of the target sample as being one of a completely dissolved state, a supersaturated state, or a turbid state based on the extracted features; and generating a control signal based on a result of the analyzing the degree of dissolution of the target sample.

The generating the control signal may include: based on the result of the analyzing indicating success, generating a control signal for proceeding with a reaction of a next operation; and based on the result of the analyzing indicating failure, generating a control signal for adding a solvent, adjusting a temperature, adjusting an agitation speed, or increasing reaction time.

The analyzing the degree of dissolution of the target sample may include: determining the at least one patterned background image based on a result of the analyzing the degree of dissolution of the target sample; and displaying the determined at least one patterned background image.

The obtaining the at least one transmission image may include: fixing or moving the container according to the control signal; and repeatedly capturing the at least one transmission image corresponding to the fixed or moved container over a period of time.

According to an aspect of an example embodiment a non-transitory computer-readable storage medium storing instructions that, when executed by a processor, may cause the processor to perform a method including: displaying at least one patterned background image according to a control signal; obtaining at least one transmission image formed by light from the at least one patterned background image being transmitted through a container accommodating a target sample, of which solubility is to be measured; and analyzing a degree of dissolution of the target sample from the at least one transmission image based on at least one analysis algorithm.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a block diagram illustrating an apparatus for measuring solubility according to an embodiment;

FIG. 2 is a diagram illustrating a configuration of an apparatus for measuring solubility according to an embodiment;

FIG. 3 is a diagram illustrating examples of patterned background images according to an embodiment;

FIG. 4 is a flowchart illustrating a method of measuring solubility according to an embodiment;

FIG. 5 is a diagram illustrating a method of displaying at least one patterned background image according to a control signal according to an embodiment;

FIG. 6 is a diagram illustrating types of at least one transmission image in which at least one patterned background image is transmitted through a container accommodating a target sample according to an embodiment;

FIG. 7 is a flowchart illustrating a method of analyzing a degree of dissolution of a target sample according to an embodiment;

FIG. 8 is a diagram illustrating a method of extracting a region of interest (ROI) from at least one transmission image according to an embodiment;

FIG. 9 is a flowchart illustrating a method of extracting features by applying an analysis algorithm for each patterned background image according to an embodiment;

FIG. 10 is a flowchart illustrating a method of extracting features by applying an analysis algorithm for each patterned background image according to an embodiment;

FIG. 11 is a flowchart illustrating an analysis algorithm for determining opacity of a solution from a transmission image according to an embodiment;

FIG. 12 is a flowchart illustrating an analysis algorithm for determining whether undissolved solute particles are present in a target sample from a transmission image according to an embodiment; and

FIG. 13 is a flowchart illustrating an analysis algorithm for determining whether residues are present around a container from a transmission image according to an embodiment.

### DETAILED DESCRIPTION

The following detailed structural or functional description is provided as an example only and various alterations and modifications may be made to the examples. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms used herein including technical or scientific terms have the same meaning as commonly understood by one of ordinary skill in the art to which examples belong. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

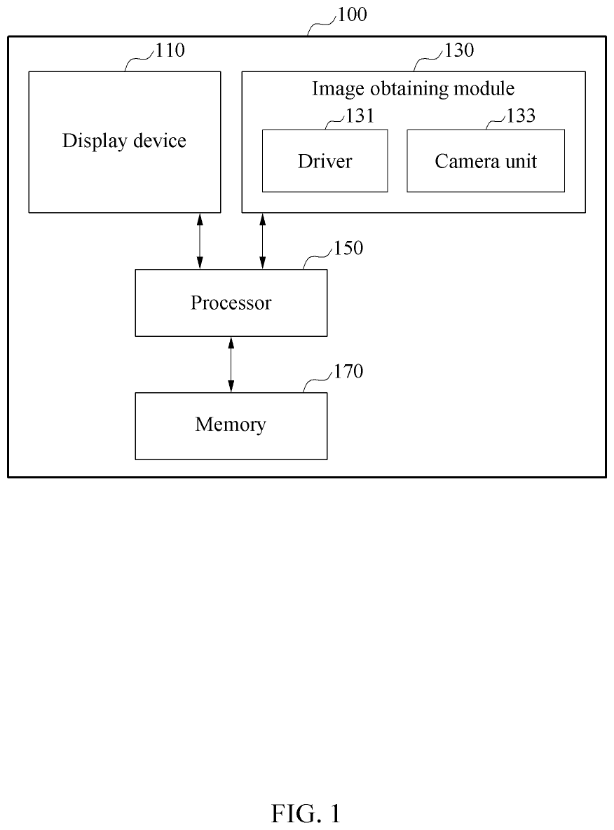

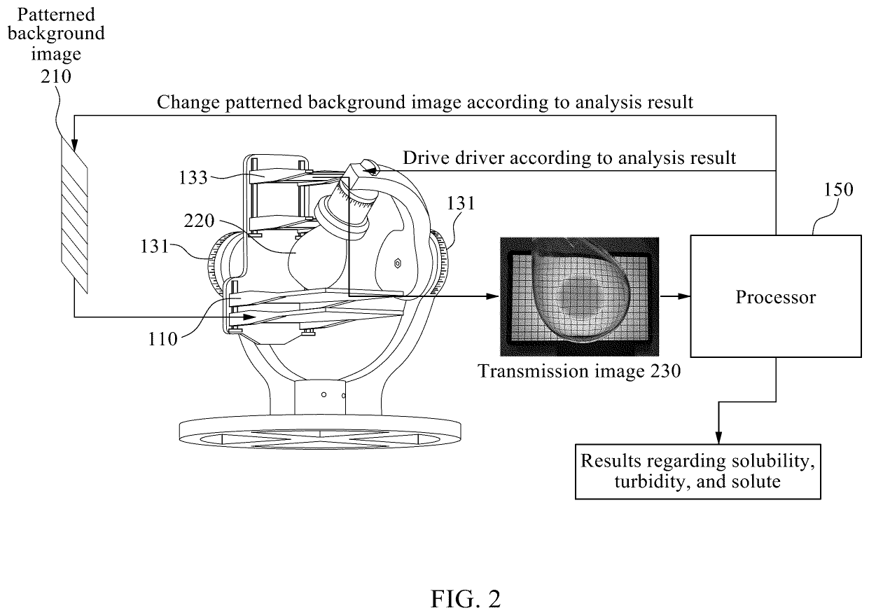

FIG. 1 is a block diagram illustrating an apparatus for measuring solubility according to an embodiment and FIG. 2 is a diagram illustrating a configuration of an apparatus for measuring solubility according to an embodiment. Referring to FIGS. 1 and 2, an apparatus for measuring solubility 100 (hereinafter, a “solubility measuring apparatus”) according to an embodiment may include a display device 110, an image obtaining module 130, and a processor 150. The solubility measuring apparatus 100 may further include a memory 170.

The display device 110 may display at least one patterned background image 210. The at least one patterned background image 210, for example, may be determined based on a result of analyzing dissolution information of a target sample by the processor 150 or may be predetermined according to an analysis algorithm. The at least one patterned background image 210 may be provided from the processor 150 or may be any one patterned background image 210 selected according to a control signal of the processor 150 from among a plurality of patterned background images 210 stored in the display device 110, but the embodiments are not limited thereto.

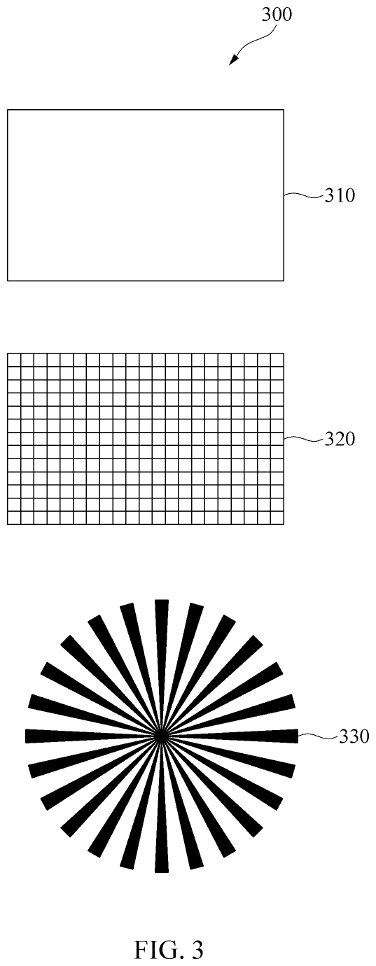

As shown in FIG. 3, the patterned background image 210 may include one or more of, for example, a white image, a checker pattern image, and/or a radial pattern image, but is not limited thereto. The patterned background image 210 may have various background patterns, various colors, and various brightness to make it easier to detect a target to be detected (e.g., opacity of a solution, presence or absence of undissolved sample particles in the solution, and/or residues around a container). In addition, the patterned background image may have a pattern designed in various forms according to, for example, solubility of a solution, in which a current target sample is dissolved, a solvent for dissolving the target sample, and properties of a solute (the target sample).

Since the solubility measuring apparatus 100 uses the at least one patterned background image 210, an image of the target sample to be analyzed and an image of elements other than the target sample (e.g., the container 220, bubbles, water droplets and bubbles on a wall of the container, etc.) may be more effectively distinguished from a transmission image 230.

The target sample may be a solid sample or a liquid sample. The liquid sample may have various forms such as, for example, liquid, paste, sludge, and viscous oil. The solid sample may have various forms such as, for example, a powder, granules, pellets, a film, and/or fibers. When the target sample is a solid sample such as a film, the solubility measuring apparatus 100 may analyze, for example, not only solubility but also whether the target sample has homogeneity or whether turbidity increases due to a reaction.

When the target sample is a liquid sample, the container 220 may have various shapes to accommodate the liquid sample so that it does not flow out. When the target sample is a liquid sample, the container 220 may include, for example, a transparent flask or a cuvette. When the target sample is a solid sample, the container 220 may be the container 220 having a flat shape so that the solid sample may be stably placed. When the target sample is a solid sample, the container 220 may include, for example, a plate or a slide.

Hereinafter, for convenience of description, a case in which the target sample is a liquid sample will be described as an example, but this does not preclude a case in which the target sample is a solid sample.

The display device 110 may generate patterned light corresponding to at least one patterned background image 210 based on an analysis algorithm and/or an analysis result of the processor 150. Alternatively, the display device 110 may display the patterned background image 210 for each analysis algorithm according to a control signal of the processor 150, or generate and display the patterned background image 210 for each analysis algorithm.

According to an embodiment, the display device 110 may include, for example, a camera module of a portable user device such as a smartphone or a tablet.

The image obtaining module 130 may obtain at least one transmission image 230 in which the at least one patterned background image 210 is transmitted through the container 220 accommodating the target sample, of which solubility is to be measured. In this case, in addition to the target sample corresponding to the solute, the container 220 may accommodate a solvent for dissolving the target sample in a state where the solvent is accommodated together with the target sample, that is, in a state of a solution in which the target sample (the solute) is dissolved in the solvent. Hereinafter, it may be understood that the container 220 accommodating the target sample refers to a container accommodating a solution in which the target sample (the solute) is dissolved in the solvent. Also, hereinafter, the target sample and the solute may be used interchangeably.

The image obtaining module 130 may include a driver 131 and a camera unit (or camera) 133.

The driver 131 may position or fix the container 220 with a posture (at a position) and/or an angle to easily obtain the at least one transmission image by transmitting the patterned background image through the target sample accommodated in the container 220. In addition, the driver 131 may provide various dynamic movements to perform operations for dissolving the target sample accommodated in the container 220 or increasing the solubility of the dissolved target sample (e.g., adjustment of a temperature of the container 220, adjustment of an agitation speed, and/or adjustment of reaction time) according to the control signal of the processor 150.

The driver 131 may include the container 220 accommodating the target sample and various equipment for fixing and/or moving the container 220 (e.g., an actuator or a rotating device for the movement of the container 220, a flask fixing device (or clamping equipment), a C-arm rotating device, a jig, driving equipment for 2 degree-of-freedom (DoF) camera alignment, driving equipment for movement of a 1 DoF slider, and/or other support equipment). The driver 131 may fix or move the container 220 accommodating the target sample according to the control signal of the processor 150. Here, the ‘movement’ may be understood to include, for example, rotation, translation, and displacement.

The driver 131 may rotatably drive the container 220 and/or the equipment for fixing the container 220 according to the control signal of the processor 150. The driver 131 may rotate the container 220 clockwise or counterclockwise according to the control signal of the processor 150. The driver 131 may change a posture of the container 220 and/or the equipment for fixing the container 220 according to the control signal of the processor 150.

The camera unit 133 may continuously capture the at least one transmission image 230 in which the at least one patterned background image 210 is transmitted through the container 220 accommodating the target sample. The camera unit 133 may continuously (or sequentially) capture the transmission image 230 in which the patterned background image 210 is transmitted through the container 220 that is fixed and/or moved by the driver 131, for example. The camera unit 133 may include a plurality of cameras or a plurality of image sensors. The camera unit 133 may transmit the continuously captured transmission images 230 to the processor 150. The camera unit 133 may capture the transmission image 230 by changing a capturing angle according to the control signal of the processor 150.

For example, when the patterned background image 210 has various shapes, the camera unit 133 may include various types of cameras (or image sensors) and flashes that are advantageous for obtaining the transmission image 230.

The display device 110 and the image obtaining module 130 may be fixed with jigs that are independently rotatable, respectively. In this case, each jig is not limited in size, may be freely rotatable, and may be finely adjusted in X, Y, and Z axis directions. Accordingly, the display device 110 and the image obtaining module 130 may be rotatable by 360 degrees, respectively, and may be moved at different angles according to a control signal which is given as feedback according to a solubility analysis result from the processor 150.

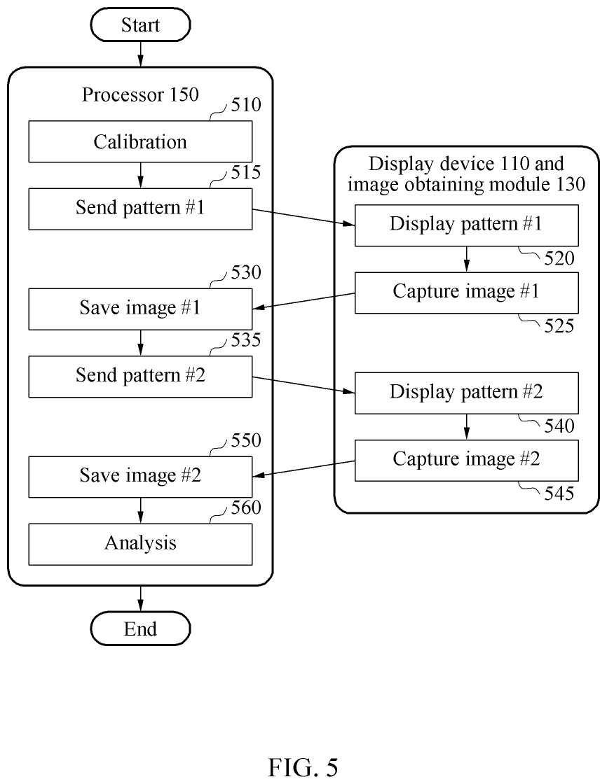

A method of displaying the at least one patterned background image 210 and obtaining the at least one transmission image 230, in which the patterned background image 210 is transmitted through the container 220 accommodating the target sample, by the solubility measuring apparatus 100 will be described in detail below with reference to FIG. 5.

The processor 150 may analyze a degree of dissolution of the target sample from the at least one transmission image 230 based on the analysis algorithm.

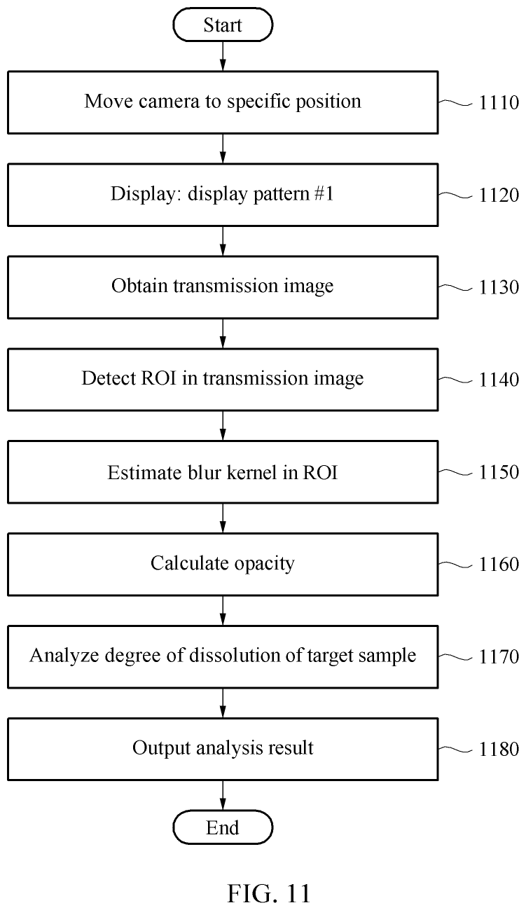

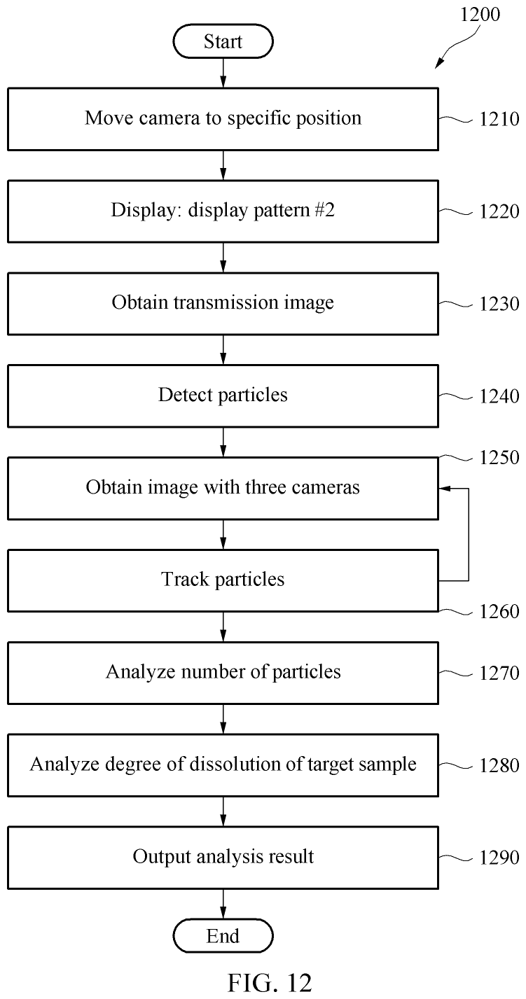

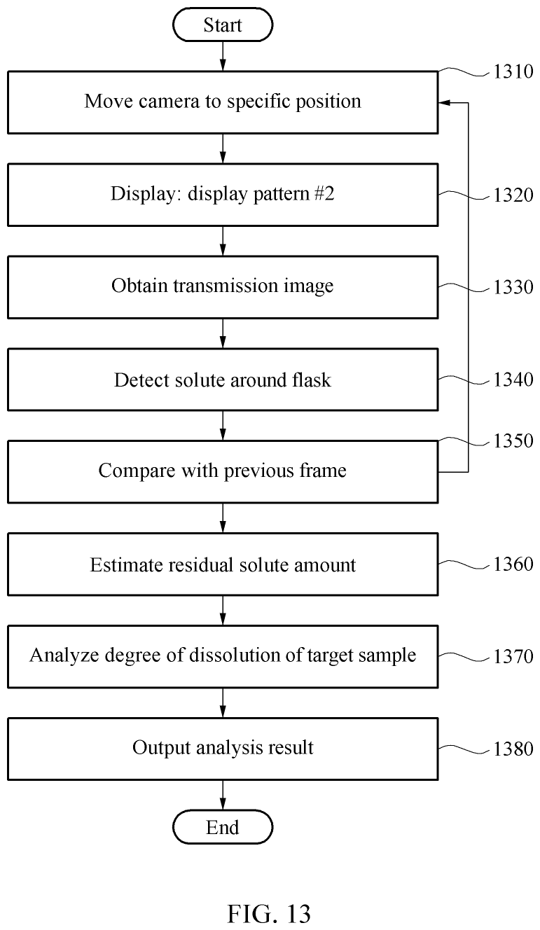

The analysis algorithm may determine, for example, from the at least one transmission image 230, at least one of whether the target sample is completely dissolved, opacity (or transparency) of the solution in which the target sample is dissolved, whether undissolved particles are present in the solution in which the target sample is dissolved, or whether residues (e.g., bubbles, water droplets, and/or dust) are present around the container. The analysis algorithm for determining the opacity of the solution from the transmission image 230 will be described below with reference to FIG. 11. The analysis algorithm for determining whether the undissolved solute particles are present in the target sample from the transmission image 230 will be described below with reference to FIG. 12. In addition, the analysis algorithm for determining whether the residues are present around the container 220 from the transmission image 230 will be described below with reference to FIG. 13.

The processor 150, for example, may analyze the degree of dissolution of the target sample by comparing an intensity of the patterned background image 210 displayed on the display device 110 with an intensity of light received from the transmission image 230, and may analyze the degree of dissolution of the target sample by determining whether a check pattern is more clearly identified in the patterned background image 210 with a check pattern.

The processor 150 may analyze the degree of dissolution of the target sample from the at least one transmission image 230 by using, for example, the analysis algorithm for each patterned background image 210 corresponding to the at least one transmission image 230. The analysis algorithm for each patterned background image 210 may include, for example, a first analysis algorithm corresponding to a white image and/or a second analysis algorithm corresponding to the patterned background image 210 with a check pattern.

The first analysis algorithm, for example, may correspond to an algorithm for analyzing the degree of dissolution of the target sample by comparing the intensity of the patterned background image 210 displayed on the display device 110 with the intensity of light received from the transmission image 230. The first analysis algorithm may include, for example, a (1-1)-th analysis algorithm for analyzing the degree of dissolution of the target sample based on uniformity in a grid corresponding to a region of interest (ROI), a (1-2)-th analysis algorithm for analyzing the degree of dissolution of the target sample based on a change in brightness and/or a change in curvature in a region corresponding to pixels of an image sensor (or a camera) corresponding to the ROI, and a (1-3)-th analysis algorithm for analyzing the degree of dissolution of the target sample based on the number of particles included in the ROI, but is not limited thereto.

The second analysis algorithm may correspond to, for example, an algorithm for analyzing the degree of dissolution of the target sample by determining whether a check pattern of a check pattern image among the patterned background images 210 is more clearly identified. The second analysis algorithm may include, for example, a (2-1)-th analysis algorithm for analyzing the degree of dissolution of the target sample by an edge detected based on a gradient obtained from the ROI, a (2-2)-th analysis algorithm for analyzing the degree of dissolution of the target sample by an attribute value of a straight line detected from a binarized image corresponding to the ROI, and a (2-3)-th analysis algorithm for analyzing the degree of dissolution of the target sample by narrowing an interval between the ROIs and removing a background pixel, but is not limited thereto.

In some embodiments, the processor 150 may analyze the degree of dissolution of the target sample from the at least one transmission image or a combination of the at least one transmission image by using a neural network trained based on the analysis algorithm.

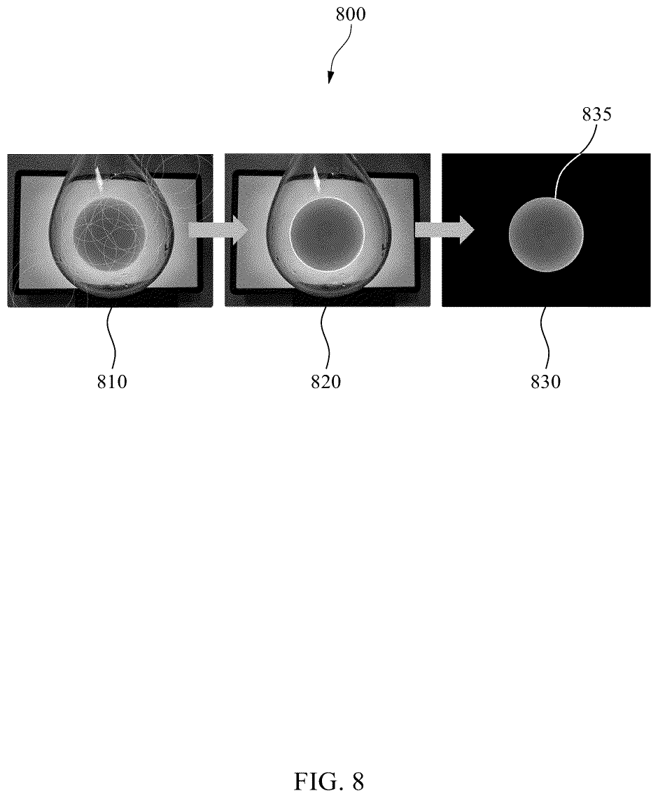

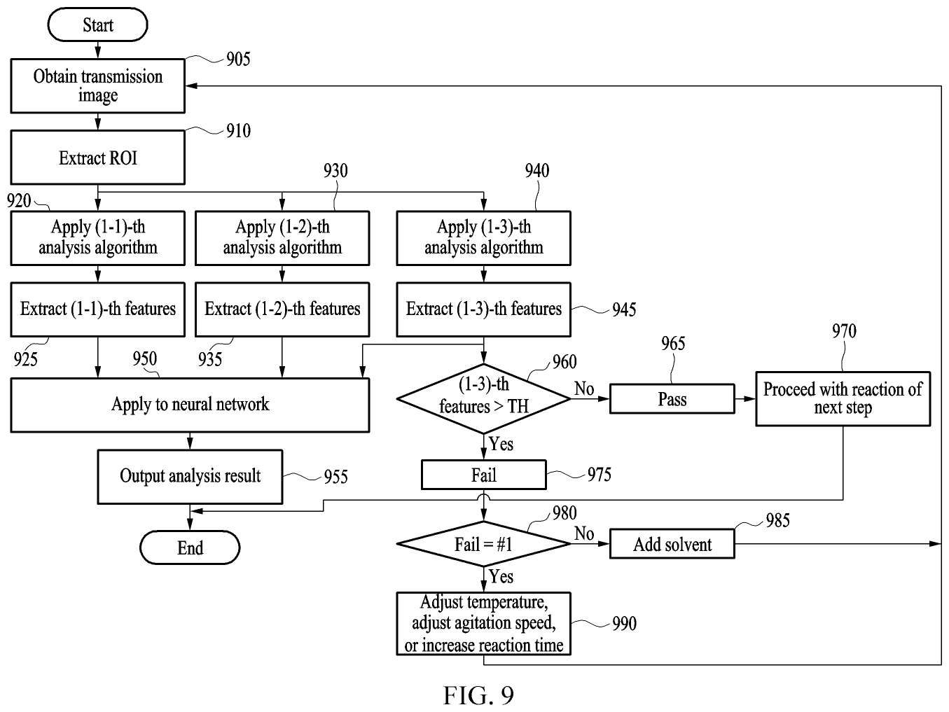

The processor 150 may extract features from the at least one transmission image 230. The processor 150 may extract, for example, a ROI from the at least one transmission image 230. A method of extracting the ROI by the processor 150 will be described below with reference to FIG. 8 below. The processor 150 may extract the features by applying, to the ROI, the analysis algorithm for each patterned background image 210 corresponding to the transmission image 230. A method of extracting the features by applying, to the ROI, the analysis algorithm for each patterned background image 210 corresponding to the transmission image 230 by the processor 150 will be described below with reference to FIG. 9.

The processor 150 may analyze the degree of dissolution of the target sample as one of, for example, a completely dissolved state, a supersaturated state, or a turbid state based on the extracted features. The processor 150, for example, may analyze the degree of dissolution of the target sample by inputting the extracted features to the analysis algorithm, or may analyze the degree of dissolution of the target sample by applying the extracted features to the neural network trained based on the analysis algorithm.

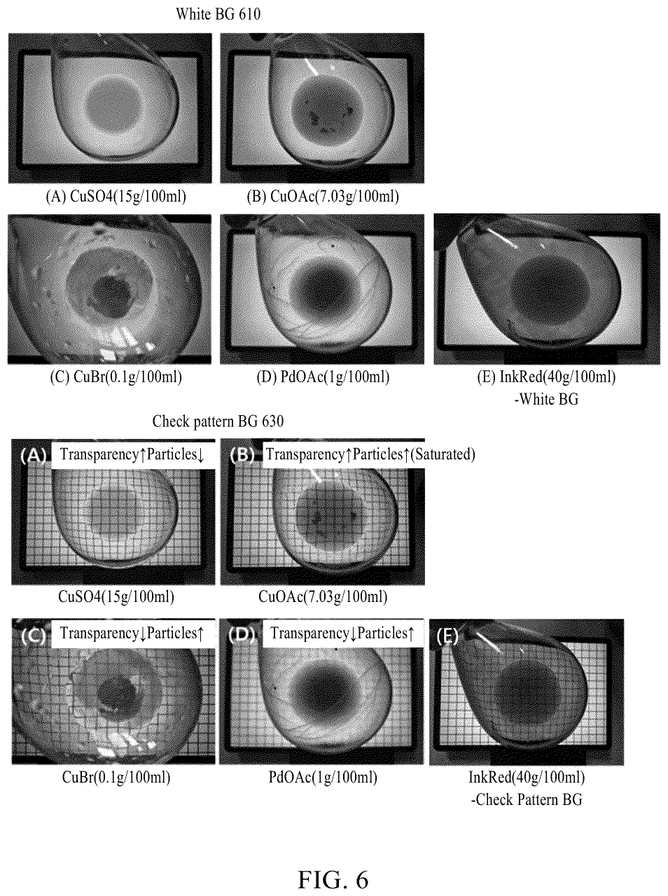

For example, as in transmission images A of a diagram 610 and a diagram 630 of FIG. 6 described below, the neural network may analyze the degree of dissolution as the “completely dissolved state” based on the features extracted from a state where the target sample (the solute) is well dissolved in the solvent and thus transparency of a solution, in which the target sample is dissolved, is high and solute particles are not present in the solution. For example, as in transmission images B of the diagram 610 and the diagram 630 of FIG. 6, the neural network may analyze the degree of dissolution as the “supersaturated state” based on the features extracted from an image in a state where the target sample is well dissolved in the solvent and thus the transparency of the solution, in which the target sample is dissolved, is high, but the solute particles are present in the solution since the target sample is not dissolved any more at concentration higher than or equal to a certain level. The “supersaturated state” may also be referred to as a “crystal state” since the solute particles are present. For example, the neural network may analyze the degree of dissolution as the “turbid state” based on the features extracted from a state where the target sample (the solute) is not dissolved at all and thus the target sample is settled as it is, and the undissolved target sample is attached to an inner wall of the container or forms a large number of water droplets, thereby being present as residues, as in transmission images C of the diagram 610 and the diagram 630 of FIG. 6, a state where most of the target sample (the solute) is not dissolved due to significantly low solubility for the solvent, most of target sample is present as a suspended matter, and thus the solution is significantly turbid as in transmission images D of the diagram 610 and the diagram 630 of FIG. 6, and/or a state where the transparency of the solution, in which the target sample is dissolved, is low, the solution, in which the target sample is dissolved, adheres to an inner wall of the flask, thus residues are present around the container, and the solute particles are present in the solution as in transmission images E of the diagram 610 and the diagram 630 of FIG. 6. The turbid state may correspond to, for example, a state where the turbidity of the solution, in which the target sample is dissolved, is high, that is, a state where the transparency of the solution is low.

The processor 150 may output, for example, the turbidity of the target sample, whether the solute is present, and the like, in addition to the solubility of the target sample. The processor 150 may output an analysis result of the degree of dissolution of the target sample by monitoring the degree of dissolution or may provide the analysis result to the display device 110 and/or the image obtaining module 130 as feedback.

For example, when the degree of dissolution of the target sample is analyzed as the completely dissolved state, the processor 150 may output “Pass” as the analysis result. On the other hand, when the degree of dissolution of the target sample is analyzed as the supersaturated state (crystal state) or the turbid state, the processor 150 may output “Fail” as the analysis result. Also, the processor 150 may classify and output the degree of dissolution of the target sample as the analysis result. For example, when the degree of dissolution of the target sample is in the turbid state, the processor 150 may output “Fail #1” as the analysis result. In addition, when the degree of dissolution of the target sample is in the supersaturation state (crystal state), the processor 150 may output “Fail #2” as the analysis result.

Since the processor 150 outputs the analysis result by dividing it into “Pass,” “Fail #1,” and “Fail #2” depending on the degree of dissolution of the target sample, a user may intuitively determine the degree of dissolution of the target sample.

The processor 150 may generate a control signal based on the analysis result. The control signal may include, for example, a control signal for fixing or moving the container 220 of the driver 131 according to the analysis result, and a control signal for displaying the at least one patterned background image 210 determined according to the analysis result. In addition, the processor 150 may generate different control signals according to, for example, whether the analysis result indicates success or failure. For example, if the analysis result indicates success, the processor 150 may generate a control signal for proceeding with a reaction of a next operation of automatic substance search after the solubility measurement. On the other hand, if the analysis result indicates failure, the processor 150 may generate a control signal for adding a solvent to the container 220, adjusting a temperature of the container 220, or adjusting an agitation speed of the driver 131, or increasing reaction time of the target sample.

The processor 150 may determine the at least one patterned background image 210 based on the analysis result and provide the determined patterned background image 210 to the display device 110.

According to an embodiment, the processor 150 may include, for example, a processor module of a user terminal such as a personal computer (PC), a notebook, or a tablet.

Alternatively, the processor 150 may drive a neural network-based analysis model by executing at least one program stored in the memory 170. The processor 150 may analyze the degree of dissolution of the target sample, whether the undissolved solute particles are present in the target sample, and whether the residues are present around the container from the transmission image obtained by the image obtaining module 130 by using a pre-trained neural network-based analysis model stored in the memory 170, and may output the analysis result. The analysis model may be trained based on various analysis algorithms. The analysis model according to an embodiment may be implemented as various types of devices, such as a PC, a server device, a mobile device, and an embedded device. The analysis model may correspond to an automatic substance search device which performs image recognition, image classification, and the like using a neural network, but is not limited thereto. In addition, the analysis model may correspond to a dedicated hardware (HW) accelerator mounted on the above device, or correspond to a HW accelerator such as a neural processing unit (NPU), a tensor processing unit (TPU), or a neural engine which is a dedicated module for driving a neural network, but is not limited thereto.

The memory 170 may store at least one program. The memory 170 may also store a variety of information generated in a processing process of the processor 150. The memory 170 may store a neural network trained based on the analysis algorithm. Also, the memory 170 may store a variety of data and programs. The memory 170 may include, for example, a volatile memory or a non-volatile memory. The memory 170 may include a high-capacity storage medium such as a hard disk to store a variety of data.

In addition, the processor 150 may perform at least one method that will be described with reference to FIGS. 3 to 13 below, in addition to FIGS. 1 and 2, or a scheme corresponding to the at least one method. The processor 150 may be a hardware-implemented solubility measuring apparatus or analyzing apparatus having a circuit that is physically structured to execute desired operations. The desired operations may include, for example, codes or instructions included in a program. The hardware-implemented solubility measuring apparatus 100 may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

FIG. 3 is a diagram illustrating examples of patterned background images according to an embodiment. FIG. 3 shows a diagram 300 showing patterned background images according to an embodiment.

The patterned background image (e.g., the patterned background image 210 of FIGS. 1 and 2) may include, for example, a white image 310, a check pattern image 320, and/or a radial pattern image 330.

The white image 310 simply displays a background without a pattern, but various brightness values may be set such that transparency and/or particles are easily detected in a transmission image.

The check pattern image 320 has horizontal and vertical check lines having the same thickness, but, unlike this, the horizontal and vertical check lines have different thicknesses, or various types of check patterns, such as a gingham check pattern in which intervals between the check patterns are different, may be used.

The radial pattern image 330 has radial lines having the same intervals, but, unlike this, the radial lines may have different intervals or a radial vortex pattern may also be used.

The solubility measuring apparatus may obtain a transmission image by, for example, displaying the check pattern image 320 and/or the radial pattern image 330 to obtain a structured light effect. The structured light effect herein may correspond to an element that is projected onto a target material to be measured to determine a difference in light and shade, a degree of coverage, or a degree of coverage over a structure when particles are present. Unlike general structured light in which incident light is “structured” to capture a subject by structuring the light itself, in an embodiment, the degree of dissolution of the target sample is analyzed by using a plurality of transmission images showing the structured light effect by transmitting various types of patterned background images through the target sample, and accordingly, the analysis regarding various points including a difference in light and shade and/or whether a degree of coverage over the structure when particles are present, not only a simple degree of covering light.

In some embodiments, by using various types of patterned background images 310, 320, and 330, an image corresponding to a target sample to be analyzed (a solution portion in which the target sample is dissolved) in the transmission image may be clearly distinguished from a partial image corresponding to a remaining portion (e.g., a container, bubbles, water droplets and bubbles on a wall of the container, dust, etc.) except for the target sample (the solution portion in which the target sample is dissolved).

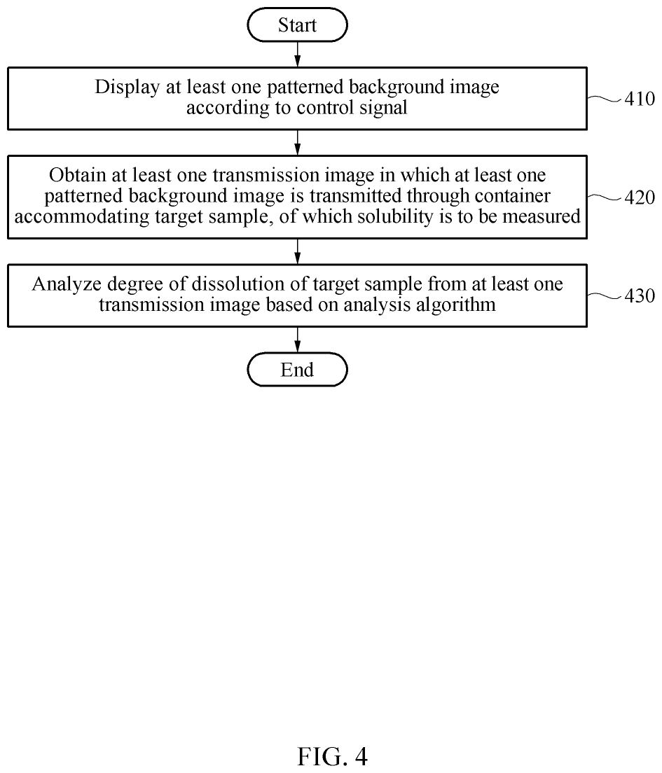

FIG. 4 is a flowchart illustrating a method of measuring solubility according to an embodiment. Operations to be described hereinafter with reference to FIG. 4 may be performed sequentially, but are not necessarily performed sequentially. For example, the order of the operations may be changed and at least two of the operations may be performed in parallel.

Referring to FIG. 4, the solubility measuring apparatus according to an embodiment may analyze the degree of dissolution of a target sample through operations 410 to 430. The solubility measuring apparatus may be, for example, the solubility measuring apparatus 100 described above with reference to FIGS. 1 and 2, but is not necessarily limited thereto.

In operation 410, the solubility measuring apparatus may display at least one patterned background image according to a control signal. A method of displaying the at least one patterned background image by the solubility measuring apparatus will be described later with reference to FIG. 5 below.

In operation 420, the solubility measuring apparatus may obtain at least one transmission image in which the at least one patterned background image displayed in operation 410 is transmitted through a container accommodating a target sample, of which solubility is to be measured. The solubility measuring apparatus may, for example, fix or move the container according to a control signal according to the analysis result and continuously capture the at least one transmission image corresponding to the fixed or moved container. Various types of transmission images obtained by the solubility measuring apparatus will be described with reference to FIG. 6 below.

In operation 430, the solubility measuring apparatus may analyze a degree of dissolution of the target sample from the at least one transmission image obtained in operation 420 based on an analysis algorithm. The analysis algorithm may determine, for example, from the at least one transmission image, at least one of whether the target sample is completely dissolved, opacity (or transparency) of the solution in which the target sample is dissolved, whether undissolved particles are present in the solution in which the target sample is dissolved, or whether residues are present around the container.

The solubility measuring apparatus may analyze the degree of dissolution of the target sample using, for example, the analysis algorithm, or may analyze the degree of dissolution of the target sample using a neural network trained by the analysis algorithm. In this case, the neural network may be, for example, a neural network in which the analysis algorithm for each patterned background image is trained.

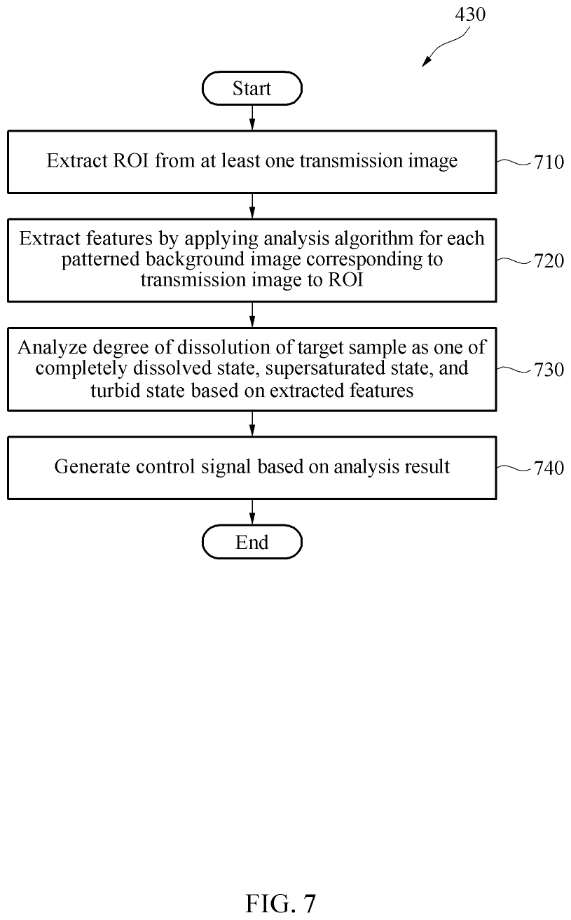

The solubility measuring apparatus may analyze the degree of dissolution of the target sample from the at least one transmission image by using the analysis algorithm for each patterned background image corresponding to the at least one transmission image. Alternatively, the solubility measuring apparatus may analyze the degree of dissolution of the target sample from the at least one transmission image or a combination of the at least one transmission image by using a neural network trained based on the analysis algorithm for each patterned background image. A method of analyzing the degree of dissolution of the target sample by the solubility measuring apparatus will be described with reference to FIG. 7 below.

The solubility measuring apparatus may determine the at least one patterned background image, provide the determined patterned background image to the display device, or transmit a control signal for displaying a specific patterned background image to the display device based on the analysis result.

FIG. 5 is a diagram illustrating a method of displaying at least one patterned background image according to a control signal according to an embodiment. FIG. 5 illustrates operations between a processor (e.g., the processor 150 of FIGS. 1 and 2) according to an embodiment, and a display device (e.g., the display device 110 of FIGS. 1 and 2) and an image obtaining module (e.g., the image obtaining module 130 of FIGS. 1 and 2).

In operation 510, the processor 150, for example, may perform calibration for positions and/or angles of the display device 110 and the image obtaining module 130 according to the analysis result of the degree of dissolution of the target sample.

When the positions of the display device 110 and the image obtaining module 130 are calibrated through operation 510, the processor 150 may sequentially provide, to the display device 110, patterned background images (e.g., a white image (pattern #1) and a check pattern image (pattern #2)) determined based on a result of analyzing the degree of dissolution of the target sample.

In operation 515, the processor 150 may provide a first patterned background image (e.g., the white image (pattern #1)) to the display device 110.

In operation 520, the display device 110 may display the white image (pattern #1) received from the processor 150 in operation 515.

In operation 525, the camera unit 133 may capture a first transmission image (image #1) in which the white image (pattern #1) displayed in operation 520 is transmitted through a container accommodating a target sample, of which solubility is to be measured. In this case, the first transmission image (image #1) may be an image including the white image (pattern #1) as a background. The camera unit 133 may transmit the captured first transmission image (image #1) to the processor 150.

In operation 530, the processor 150 may store the first transmission image (image #1) transmitted from the camera unit 133.

In operation 535, the processor 150 may provide a next patterned background image (e.g., a check pattern image (pattern #2)) to the display device 110.

In operation 540, the display device 110 may display the check pattern image (pattern #2) received from the processor 150 in operation 535.

In operation 545, the camera unit 133 may capture a second transmission image (image #2) in which the check pattern image (pattern #2) displayed in operation 540 is transmitted through the container accommodating the target sample, of which solubility is to be measured. In this case, the second transmission image (image #2) may be an image including the check pattern image (pattern #2) as a background. The camera unit 133 may transmit the captured second transmission image (image #2) to the processor 150.

In operation 550, the processor 150 may store the second transmission image (image #2) transmitted from the camera unit 133.

In operation 560, the processor 150 may analyze a degree of dissolution of the target sample by using the first transmission image (image #1) stored in operation 530 and the second transmission image (image #2) stored in operation 550.

The processor 150 may analyze the degree of dissolution of the target sample, for example, by combining both the transmission image (image #1) and the second transmission image (image #2). For example, when the patterned background image is the white image (pattern #1), the processor 150 may extract first features from the first transmission image (image #1) by the first analysis algorithm corresponding to the white image, and may analyze the degree of dissolution of the target sample by applying the extracted first features to an analysis algorithm or a neural network. In addition, when the patterned background image is the check pattern image (pattern #2), the processor 150 may extract second features from the second transmission image (image #2) by the second analysis algorithm corresponding to the check pattern image, and may analyze the degree of dissolution of the target sample by applying the extracted second features to an analysis algorithm or a neural network. The processor 150 may output a final analysis result (e.g., pass or fail) by combining or adding an analysis result based on the first features and an analysis result based on the second features.

Alternatively, the processor 150 may analyze the degree of dissolution of the target sample by an analysis algorithm for each patterned background image. The processor 150 may output the analysis result based on the first features or the analysis result based on the second features as the final analysis result, respectively, in the process described above.

According to an embodiment, the processor 150 may analyze the degree of dissolution of the target sample from a combination of the first transmission image (image #1) and the second transmission image (image #2), that is, a combined image of the first transmission image and the second transmission image.

FIG. 6 is a diagram illustrating types of at least one transmission image in which at least one patterned background image is transmitted through a container accommodating a target sample according to an embodiment. FIG. 6 illustrates the diagram 610 showing transmission images A, B, C, D, and E captured when the patterned background image is a white image, and the diagram 630 showing transmission images A, B, C, D, and E captured when the patterned background image is a check pattern image according to an embodiment.

The transmission images A, B, C, D, and E in each of the diagrams 610 and 630 show representative types in which a target sample corresponding to a solute may be present in a solvent. Hereinafter, the “solute” may refer to the target sample and the “particles” may refer to particles of the target sample.

The transmission image A may correspond to a case where the solute is dissolved in the solvent in a very clean state due to significantly high solubility.

The transmission image B may correspond to a case where the solute is dissolved well in the solvent, but is present as solute particles, since the solute is not dissolved any more at concentration higher than or equal to a certain level.

The transmission image C may correspond to a case where the solute is not dissolved in the solvent at all, the input solute is settled as it is, and the undissolved solute is attached to an inner wall of the container or forms a large number of water droplets, thereby being present as residues.

The transmission image D may correspond to a case where most of the solute is not dissolved due to significantly low solubility and floats as a suspended matter, and thus a solution is significantly turbid in the container.

The transmission image E may correspond to a case where only some of the solute is dissolved in the solvent due to significantly low solubility and thus the dissolved solute is present on an inner wall and a bottom portion of the container as residues.

The solubility measuring apparatus may analyze the degree of dissolution of the target sample as one of, for example, the completely dissolved state, the supersaturated state, and the turbid state and may output the analysis result (pass or fail) by applying the features extracted from various types of the obtained transmission images to an analysis algorithm or a neural network trained based on the analysis algorithm.

For example, as in the transmission images A of the diagram 610 and the diagram 630, the solubility measuring apparatus may analyze as the “completely dissolved state” for the features extracted from the images in which the target sample (the solute) is well dissolved in the solvent so that transparency of a solution, in which the target sample is dissolved, is high and solute particles are not present in the solution. As in the transmission images B of the diagram 610 and the diagram 630, the solubility measuring apparatus may analyze as the “supersaturated state” for the features extracted from the images in which the target sample is well dissolved in the solvent and thus the transparency of the solution, in which the target sample is dissolved, is high, but the solute particles are present in the solution since the target sample is not dissolved any more at concentration higher than or equal to a certain level. The “supersaturated state” may also be referred to as a “crystal state” since the solute particles are present.

For example, the solubility measuring apparatus may analyze as the “turbid state” for the features extracted from the images in which the target sample (the solute) is not dissolved at all and thus the target sample is settled as it is, and the undissolved target sample is attached to an inner wall of the container or forms a large number of water droplets, thereby being present as residues, as in the transmission images C of the diagram 610 and the diagram 630, the images in which most of the target sample (the solute) is not dissolved due to significantly low solubility for the solvent, most of the target sample is present as a suspended matter, and thus the solution is significantly turbid as in the transmission images D, and/or the images in which the transparency of the solution, in which the target sample is dissolved, is low, the solution, in which the target sample is dissolved, adheres to an inner wall of the flask, thus residues are present around the container, and the solute particles are present in the solution as in the transmission images E.

FIG. 7 is a flowchart illustrating a method of analyzing a degree of dissolution of a target sample according to an embodiment. Operations to be described hereinafter with reference to FIG. 7 may be performed sequentially, but are not necessarily performed sequentially. For example, the order of the operations may be changed and at least two of the operations may be performed in parallel. Referring to FIG. 7, a solubility measuring apparatus (e.g., the solubility measuring apparatus 100 of FIGS. 1 and 2) according to an embodiment may analyze the degree of dissolution of the target sample through operations 710 to 740.

In operation 710, the solubility measuring apparatus may extract an ROI from at least one transmission image. A method of extracting the ROI by the solubility measuring apparatus will be described with reference to FIG. 8 below.

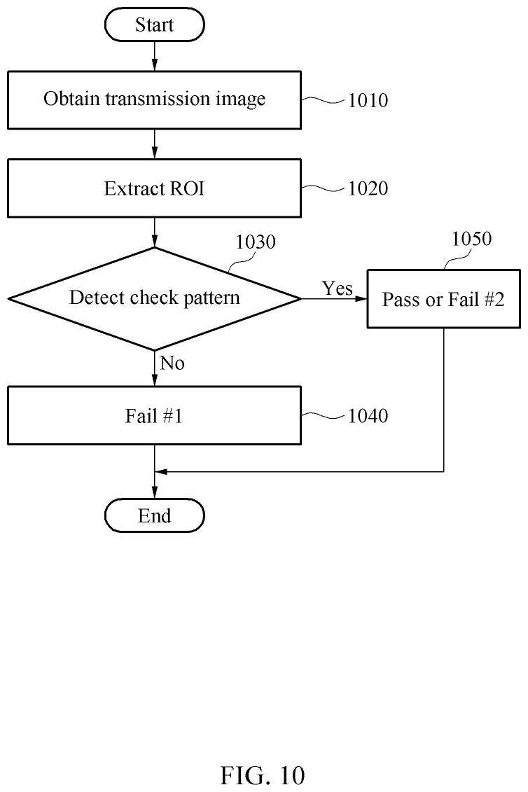

In operation 720, the solubility measuring apparatus may extract features by applying an analysis algorithm for each patterned background image corresponding to a transmission image to the ROI extracted in operation 710. A method of extracting the features by applying the analysis algorithm for each patterned background image by the solubility measuring apparatus will be described in more detail with reference to FIGS. 9 and 10 below.

In operation 730, the solubility measuring apparatus may analyze the degree of dissolution of the target sample as one of the completely dissolved state, the supersaturated state, and the turbid state based on the features extracted in operation 720. The solubility measuring apparatus may analyze the degree of dissolution of the target sample by inputting the extracted features to an analysis algorithm or applying the extracted features to a neural network trained based on the analysis algorithm. In this case, the neural network may be pre-trained based on analysis algorithm(s) corresponding to various types of transmission images. The analysis algorithms corresponding to the various types of transmission images will be described in more detail with reference to FIGS. 11 to 13 below.

In operation 740, the solubility measuring apparatus may generate a control signal based on the analysis result of operation 730. For example, when the analysis result in operation 730 indicates success, the solubility measuring apparatus may generate a control signal for proceeding with a reaction of a next operation. On the other hand, when the analysis result indicates failure, the solubility measuring apparatus may generate a control signal for adding a solvent, adjusting a temperature, adjusting an agitation speed, or increasing reaction time.

For example, when the analysis result is “Fail #1,” the degree of dissolution of the target sample corresponds to the turbid state. Accordingly, the solubility measuring apparatus may generate the control signal for adjusting the temperature, adjusting the agitation speed, or increasing the reaction time to increase the degree of dissolution of the target sample and transmit the control signal to the driver. When the analysis result is “Fail #2,” the degree of dissolution of the target sample corresponds to the supersaturated state (the crystal state). Accordingly, the solubility measuring apparatus may generate the control signal for adding the solvent and transmit the control signal to the driver or a user.

FIG. 8 is a diagram illustrating a method of extracting an ROI from at least one transmission image according to an embodiment. FIG. 8 shows a diagram 800 illustrating a process of extracting a circular portion 835 corresponding to the ROI, as shown in an image 830, from a transmission image 810 obtained in a case where a white image is used as a patterned background image according to an embodiment.

For example, when the transmission image 810 is obtained, the solubility measuring apparatus may generate an image 820 in which virtual lines for finding a circle are removed from the transmission image 810. When a circle is found in the image 810 by the virtual lines, the solubility measuring apparatus may remove data outside the circle and perform the solubility analysis by extracting an inner circle and selecting the circle as the ROI. In this case, for example, the Circle Hough Transform may be used to extract the circle, but the method is not limited thereto. In the Circle Hough Transform, a two-dimensional histogram for center points a and b of a circle is selected on an edge detected in an image by using a gradient method, and all points on an accumulation plane are increased along a line segment of a gradient from a minimum distance to a maximum distance for all points, thereby extracting a circle. In this case, the accumulation plane may be a three-dimensional accumulation plane including a center point x of the circle, a center point y of the circle, and a radius r of the circle.

The solubility measuring apparatus may extract the circular portion 835 corresponding to the solution as the ROI, as shown in the image 830, from the image 820 in which the virtual lines are removed. In this case, a size of the ROI is set differently depending on the opacity of the solution (the solution in which the target sample is dissolved) displayed in the image 820, whether the undissolved particles are present in the solution, and/or whether the residues are present around the container. For example, when the residues are present around the container, the size of the ROI may set to be larger than the circular portion 835 corresponding to the solution.

FIG. 9 is a flowchart illustrating a method of extracting features by applying an analysis algorithm for each patterned background image according to an embodiment. Operations to be described hereinafter with reference to FIG. 9 may be performed sequentially, but are not necessarily performed sequentially. For example, the order of the operations may be changed and at least two of the operations may be performed in parallel.

Referring to FIG. 9, a solubility measuring apparatus (e.g., the solubility measuring apparatus 100 of FIGS. 1 and 2) according to an embodiment may analyze a degree of dissolution of a target sample from a transmission image by applying a first analysis algorithm corresponding to a patterned background image (e.g., a white image) through operations 905 to 990.

In operation 905, the solubility measuring apparatus may obtain a transmission image in which the patterned background image (e.g., the white image) is transmitted through a container accommodating the target sample.

In operation 910, the solubility measuring apparatus may extract an ROI from the transmission image obtained in operation 905. The solubility measuring apparatus may extract, from the transmission image, for example, a partial image corresponding to a solution or a partial image corresponding to a solution and a container accommodating the solution as the ROI.

The solubility measuring apparatus may extract features by applying the first analysis algorithm corresponding to the patterned background image (e.g., the white image) to the image of the ROI extracted in operation 910.

In operation 920, the solubility measuring apparatus may apply a (1-1)-th analysis algorithm to the ROI extracted in operation 910. The (1-1)-th analysis algorithm may correspond to an algorithm for analyzing the degree of dissolution of the target sample based on uniformity and brightness in a grid corresponding to the ROI. The (1-1)-th analysis algorithm may include, for example, a grid homogeneity analysis algorithm, but is not limited thereto.

In operation 925, the solubility measuring apparatus may extract (1-1)-th features (e.g., mean of mean of grid, mean of std of grid, std of mean of grid, and std of std of grid) corresponding to a result of applying the (1-1)-th analysis algorithm to the ROI in operation 920.

In operation 930, the solubility measuring apparatus may apply a (1-2)-th analysis algorithm to the image of the ROI extracted in operation 910. The (1-2)-th analysis algorithm may correspond to an algorithm for analyzing the degree of dissolution of the target sample based on a change in brightness and/or a change in curvature in a region corresponding to pixels of an image sensor (a camera) corresponding to the ROI. The (1-2)-th analysis algorithm may include, for example, a radial profiling algorithm, but is not limited thereto.

In operation 935, the solubility measuring apparatus may extract (1-2)-th features (e.g., std range and curvature) corresponding to a result of applying the (1-2)-th analysis algorithm to the ROI in operation 930.

In operation 940, the solubility measuring apparatus may apply a (1-3)-th analysis algorithm to the image of the ROI extracted in operation 910. The (1-3)-th analysis algorithm may correspond to an algorithm for analyzing the degree of dissolution of the target sample based on the number of solute particles included in the ROI. The (1-3)-th analysis algorithm may include, for example, a particle segmentation algorithm, but is not limited thereto.

In operation 945, the solubility measuring apparatus may extract (1-3)-th features (e.g., particle sum) corresponding to a result of applying the (1-3)-th analysis algorithm to the ROI in operation 940.

All of operations 920, 930, and 940 may be simultaneously performed or operations 920, 930, and 940 may be sequentially performed.

In operation 950, the solubility measuring apparatus may apply the (1-1)-th features extracted in operation 925, the (1-2)-th features extracted in operation 935, and the (1-3)-th features extracted in operation 945 to analysis algorithm(s) or a neural network trained based on the analysis algorithm(s). The solubility measuring apparatus may analyze the degree of dissolution of the target sample by individually applying the (1-1)-th features, the (1-2)-th features, and the (1-3)-th features to the analysis algorithms or the neural network, or may analyze the degree of dissolution of the target sample by applying the (1-1)-th features, the (1-2)-th features, and the (1-3)-th features together to the analysis algorithms or the neural network.

In operation 955, the solubility measuring apparatus may output the analysis result of operation 950.

According to an embodiment, the solubility measuring apparatus may analyze the degree of dissolution of the target sample by using the (1-3)-th features extracted as a result of applying the (1-3)-th analysis algorithm in operation 945 without applying to the neural network. In this case, the (1-3)-th features may correspond to, for example, the number of solute particles included in the ROI.

Accordingly, the solubility measuring apparatus may more rapidly output the analysis result of the degree of dissolution of the target sample according to the number of the solute particles included in the ROI.

In operation 960, the solubility measuring apparatus may determine whether the number of the (1-3)-th features (the number P of the solute particles) is larger than a threshold value TH. In this case, the threshold value TH, for example, may be a value larger than the number P1 of solute particles included in a solution in the completely dissolved state, where the solute particles are substantially not present in the solution due to high solubility of the solution, in which the target sample is dissolved, and may be a value smaller than or equal to the number P₂ of solute particles included in a solution in the crystal state (or the supersaturated state) where the solute extracted from the solution is well dissolved in the solvent but is not dissolved any more at concentration higher than or equal to a certain level, thereby being present as the solute particles, as shown in an image, but is not limited thereto.

In operation 965, when it is determined that the number of the solute particles is smaller than or equal to the threshold value TH in operation 960, the solubility measuring apparatus may analyze the degree of dissolution of the target sample as the completely dissolved state, output “Pass” as an analysis result, and proceed with a reaction of a next operation in operation 970.

In operation 975, when it is determined that the number of the solute particles is larger the threshold value TH in operation 960, the solubility measuring apparatus may analyze that a large number of particles of the undissolved target sample is present in the solution and thus determine the analysis result as “Fail.”

In operation 980, the solubility measuring apparatus may determine whether the type of the analysis result (Fail) is “Fail #1” corresponding to the turbid state or “Fail #2” corresponding to the supersaturated state. In this case, the solubility measuring apparatus may determine the type of the analysis result in consideration of the transparency (or opacity) of the solution displayed in the ROI and/or whether the residues are present around the container together, in addition to the number of solute particles.

For example, when the number P of the solute particles greatly exceeds the threshold value TH and the opacity of the solution displayed in the ROI is high, the solubility measuring apparatus may determine that the type of the analysis result (Fail) is “Fail #1” corresponding to the turbid state. On the other hand, when the number P of the solute particles is equal to or slightly larger than the threshold value TH and the transparency of the solution displayed in the ROI is high, the solubility measuring apparatus may determine that the type of the analysis result (Fail) is “Fail #2” corresponding to the supersaturated state.

When it is determined that the type of the analysis result (Fail) is “Fail #1” in operation 980, the degree of dissolution of the target sample may correspond to the turbid state. In this case, in operation 990, the solubility measuring apparatus may generate a control signal for adjusting a temperature, adjust an agitation speed, or increasing reaction time to increase the degree of dissolution of the target sample and may transmit the control signal to the driver. Then, the solubility measuring apparatus may return to operation 905 and obtain a transmission image after the temperature is adjusted, the agitation speed is adjusted, or the reaction time is increased according to the control signal.

When it is determined that the type of the analysis result (Fail) is “Fail #2” in operation 980, the degree of dissolution of the target sample may correspond to the supersaturated state (crystal state). In this case, in operation 985, the solubility measuring apparatus may generate a control signal for adding a solvent and transmit the control signal to the driver or the user. Then, the solubility measuring apparatus may return to operation 905 and obtain a transmission image after the solvent is added according to the control signal.

FIG. 10 is a flowchart illustrating a method of extracting features by applying an analysis algorithm for each patterned background image according to an embodiment. Operations to be described hereinafter with reference to FIG. 10 may be performed sequentially, but are not necessarily performed sequentially. For example, the order of the operations may be changed and at least two of the operations may be performed in parallel.

Referring to FIG. 10, a solubility measuring apparatus (e.g., the solubility measuring apparatus 100 of FIGS. 1 and 2) according to an embodiment may analyze a degree of dissolution of a target sample from a transmission image by applying a second analysis algorithm corresponding to a patterned background image (e.g., a check pattern image) through operations 1010 to 1050.

In operation 1010, the solubility measuring apparatus may obtain the transmission image in which the patterned background image (e.g., the check pattern image) is transmitted through a container accommodating the target sample.

In operation 1020, the solubility measuring apparatus may extract an ROI from the transmission image obtained in operation 1010. The solubility measuring apparatus may extract, from the transmission image, for example, a partial image corresponding to a solution or a partial image corresponding to a solution and a container accommodating the solution as the ROI.

In operation 1030, the solubility measuring apparatus may determine whether a check pattern is clearly detected by features obtained by applying the second analysis algorithm(s) to an image of the ROI extracted in operation 1020.

In this case, the second analysis algorithm(s) may be, for example, a (2-1)-th analysis algorithm for analyzing the degree of dissolution of the target sample by an edge of the check pattern detected based on a gradient obtained from the ROI. The second analysis algorithm may be, for example, a (2-2)-th analysis algorithm for analyzing the degree of dissolution of the target sample by an attribute value of a straight line (the check pattern) detected from a binarized image corresponding to the ROI. Alternatively, the second analysis algorithm may be, for example, a (2-3)-th analysis algorithm for analyzing the degree of dissolution of the target sample by narrowing an interval between check patterns in the ROI and removing a background pixel.

The (2-1)-th analysis algorithm may include, for example, a Canny edge detection algorithm, but is not limited thereto. The (2-2)-th analysis algorithm may include, for example, a Hough lines algorithm, but is not limited thereto. Furthermore, the (2-3)-th analysis algorithm may include, for example, a Morphology Close algorithm, but is not limited thereto.

In operation 1030, the solubility measuring apparatus may divide the image (the ROI) into several regions, and use adaptive thresholding for designating a threshold value for each region by calculating a mean or a Gaussian distribution based on pixel values around the regions to obtain a clearer image.

For example, in operation 1040, when a blurred, partially broken, or smudged check pattern corresponding to the ROI is detected in operation 1030, the solubility measuring apparatus may output the analysis result as “Fail #1” by analyzing the degree of dissolution of the target sample as the “turbid state.”

On the other hand, in operation 1050, when the check pattern is clearly detected in operation 1030, the solubility measuring apparatus may output the analysis result as “Pass” by analyzing the degree of dissolution of the target sample as the “completely dissolved state” or may output the analysis result as “Fail #2” by analyzing the degree of dissolution of the target sample as the “supersaturated state (crystal state).” In this case, the solubility measuring apparatus may determine the analysis result as “Pass” or “Fail #2” according to a ratio of superposition of check patterns to the entire check pattern in the ROI. For example, when the number of a sum of superposition/a sum of grid mask in the check pattern exceeds a certain level, the solubility measuring apparatus may output the analysis result as “Fail #2” by analyzing the degree of dissolution of the target sample as the “supersaturated state (crystal state).”

FIG. 11 is a flowchart illustrating an analysis algorithm for determining opacity of a solution from a transmission image according to an embodiment. Operations to be described hereinafter with reference to FIG. 11 may be performed sequentially, but are not necessarily performed sequentially. For example, the order of the operations may be changed and at least two of the operations may be performed in parallel.

Referring to FIG. 11, a solubility measuring apparatus (e.g., the solubility measuring apparatus 100 of FIGS. 1 and 2) according to an embodiment may measure opacity of a solution, in which a target sample is dissolved, as a solubility estimate (%) of the solution and output a result of measuring through operations 1110 to 1180.

In operation 1110, the solubility measuring apparatus may move a camera to a specific position. The specific position herein may correspond to, for example, a position for accurately capturing an image of a container accommodating the solution, in which the target sample is dissolved, but is not limited thereto. The solubility measuring apparatus may move and fix a camera unit (e.g., the camera unit 133 of FIGS. 1 and 2) and a display device (e.g., the display device 110 of FIGS. 1 and 2) to specific positions by the driver described above (e.g., the driver 131 of FIGS. 1 and 2).

In operation 1120, the solubility measuring apparatus may display a patterned background image (e.g., the white image (pattern #1)) on the display device. The solubility measuring apparatus may display, for example, a patterned background image having a high frequency component capable of specifying blurring in the transmission image. In this case, the patterned background image may have patterns designed in various forms according to the solubility of a solution, in which a current target sample is dissolved, a solvent for dissolving the target sample, and properties of a solute (the target sample). In addition, as the patterned background image has various patterns, the solubility measuring apparatus may use various types of cameras (or image sensors) and/or flashes to obtain the transmission image.

In operation 1130, the solubility measuring apparatus may obtain at least one transmission image, in which the patterned background image displayed in operation 1120 is transmitted through a container accommodating the target sample, of which solubility is to be measured.

In operation 1140, the solubility measuring apparatus may detect an ROI in the transmission image obtained in operation 1130. The solubility measuring apparatus may detect the ROI from the transmission image using, for example, geometric characteristics, color information, and the like of a solvent and/or a solute (the target sample).

In operation 1150, the solubility measuring apparatus may estimate a blur kernel in the ROI detected in operation 1140. The blur kernel herein may refer to a state where an image in the ROI is opaque and not uniform. The solubility measuring apparatus may estimate the solubility of the solution by using a degree of blurring of the patterned background image obtained in the ROI. The solubility measuring apparatus may measure the solubility of the solution as the solubility estimate (%). The solubility measuring apparatus, for example, may measure the solubility estimate (%) as a value less than 50% with respect to the analysis result indicating “Fail #1,” may measure the solubility estimate (%) as 50% to 100% with respect to the analysis result indicating “Pass,” and may measure the solubility estimate (%) as 100% or more with respect to the analysis result indicating “Fail #2.”

In operation 1160, the solubility measuring apparatus may calculate the opacity of the solution, in which the target sample is dissolved, based on a result of estimating the blur kernel in operation 1150. The solubility measuring apparatus may improve the accuracy of the opacity calculation by, for example, repeatedly performing operations from operation 1130 of obtaining the transmission image to operation 1160 of calculating of the opacity of the solution a predetermined number of times. Here, the predetermined number of times may correspond to, for example, the number of structured light rays formed by the patterned background images, but is not limited thereto.

In operation 1170, the solubility measuring apparatus may analyze the degree of dissolution of the target sample based on the opacity of the solution calculated in operation 1160, and may output an analysis result in operation 1180.

FIG. 12 is a flowchart illustrating an analysis algorithm for determining whether undissolved sample particles are present in a target sample from a transmission image according to an embodiment. Operations to be described hereinafter with reference to FIG. 12 may be performed sequentially, but are not necessarily performed sequentially. For example, the order of the operations may be changed and at least two of the operations may be performed in parallel.

Referring to FIG. 12, a solubility measuring apparatus (e.g., the solubility measuring apparatus 100 of FIGS. 1 and 2) according to an embodiment may detect undissolved particles in a solution, in which a target sample is dissolved, through operations 1210 to 1290 by applying a fine particle tracking algorithm. Hereinafter, the particles may be understood as particles of a target sample corresponding to a solute, although there is no particular description.

In operation 1210, the solubility measuring apparatus may move a camera to a specific position. The specific position herein may correspond to, for example, a position for accurately capturing an image of a container accommodating the solution, in which the target sample is dissolved, but is not limited thereto. The solubility measuring apparatus may move and fix a camera and a display device to a position for particle estimation (e.g., a position tilted by 45 degrees from the container) by the driver described above (e.g., the driver 131 of FIGS. 1 and 2).

In operation 1220, the solubility measuring apparatus may display a patterned background image (e.g., the check pattern image (pattern #2)) on the display device. The solubility measuring apparatus may display, for example, the patterned background image in which a pattern for detecting particles is displayed in the transmission image. The patterned background image may have, for example, a pattern, in which a color and/or brightness value for easily detecting particles are set, while displaying a simple background with no patterns.

In operation 1230, the solubility measuring apparatus may obtain at least one transmission image in which the patterned background image displayed in operation 1220 is transmitted through a container accommodating a target sample, of which solubility is to be measured. In this case, the transmission image may be an image for detecting particles.

In operation 1240, the solubility measuring apparatus, for example, may detect sample particles from the transmission image obtained in operation 1230 by using an analysis algorithm or a deep neural network (DNN) trained based on the analysis algorithm.

In operation 1250, the solubility measuring apparatus may capture continuous images of the container accommodating the sample particles by using, for example, three cameras on a back side of the container accommodating the target sample.

In operation 1260, the solubility measuring apparatus may track the particles in the continuous images captured in operation 1250. The solubility measuring apparatus may distinguish actual sample particles from erroneously detected particles by tracking the particles detected in operation 1240 in the continuous images by using the fine particle tracking algorithm.

In operation 1270, the solubility measuring apparatus may analyze the number of actual sample particles distinguished in operation 1260.

In operation 1280, the solubility measuring apparatus may analyze a degree of dissolution of the target sample by estimating the solubility using the number of sample particles analyzed in operation 1270.

In operation 1290, the solubility measuring apparatus may output a result of analyzing in operation 1280.

FIG. 13 is a flowchart illustrating an analysis algorithm for determining whether residues are present around a container from a transmission image according to an embodiment. Operations to be described hereinafter with reference to FIG. 13 may be performed sequentially, but are not necessarily performed sequentially. For example, the order of the operations may be changed and at least two of the operations may be performed in parallel.

Referring to FIG. 13, through operations 1310 to 1380, a solubility measuring apparatus (e.g., the solubility measuring apparatus 100 of FIGS. 1 and 2) according to an embodiment may determine whether a residual solute in a solid state is present around a container accommodating a solution in which a sample is dissolved after complete vaporization.

In operation 1310, the solubility measuring apparatus may move a camera to a specific position. The specific position herein may correspond to, for example, a position capable of performing the continuous capturing of an image of a container (e.g., a flask) accommodating a solution, in which a target sample is dissolved, but is not limited thereto. The solubility measuring apparatus may rotate the container to tilt by a certain angle (e.g., 45 degrees) in a transverse direction by the driver described above (e.g., the driver 131 of FIGS. 1 and 2) to enable the continuous capturing of the image of the container.

In operation 1320, the solubility measuring apparatus may display a patterned background image (e.g., the check pattern image (pattern #2)) which makes it easy to confirm the residual solute through the display device. The solubility measuring apparatus may display, for example, a patterned background image which makes it easy to confirm the residual solute in the transmission image. The patterned background image may have, for example, a pattern, in which a color and/or brightness value for easily detecting the residual solute are set, while displaying a simple background with no patterns.

In operation 1330, the solubility measuring apparatus may obtain at least one transmission image in which the patterned background image displayed in operation 1320 is transmitted through the container accommodating the target sample, of which solubility is to be measured. In this case, the transmission image may be an image for confirming the residual solute.

In operation 1340, the solubility measuring apparatus may detect the residual solute around the container from the transmission image obtained in operation 1330. The solubility measuring apparatus may detect the residual solute around the container in consideration of, for example, properties of a glass material and reflected light.

In operation 1350, the solubility measuring apparatus may compare a current frame with a previous frame in continuous images captured by using a plurality of cameras on a rear side of the container accommodating the target sample. The solubility measuring apparatus may calculate a first position of the residual solute around the container detected in the previous frame and may remove an erroneously detected residual solute by comparing the first position with a region where the residual solute around the container is detected from the current frame.

In operation 1360, the solubility measuring apparatus may remove the residual solute erroneously detected in operation 1350 and estimate a residual solute amount. The solubility measuring apparatus may estimate a final residual solute amount by summing the results of detecting the solute around the container through a plurality of images.

In operation 1370, the solubility measuring apparatus may analyze a degree of dissolution of the target sample by estimating the solubility using the final residual solute amount estimated in operation 1360.

In operation 1380, the solubility measuring apparatus may output a result of analyzing in operation 1370.

The embodiments described herein may be implemented using a hardware component, a software component and/or a combination thereof. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An apparatus for measuring solubility, the apparatus comprising:
a display configured to display at least one patterned background image;
a camera configured to obtain at least one transmission image formed by light from the at least one patterned background image being transmitted through a container accommodating a target sample, of which solubility is to be measured; and
a processor configured to analyze a degree of dissolution of the target sample from the at least one transmission image based on using at least one analysis algorithm.

2. The apparatus of claim 1, wherein the processor is further configured to use the at least one analysis algorithm to determine, from the at least one transmission image, at least one of:
whether the target sample is completely dissolved,
opacity of a solution in which the target sample is dissolved,
whether undissolved particles are present in the solution in which the target sample is dissolved, or
whether residues are present around the container.

3. The apparatus of claim 1, wherein the processor is further configured to:
analyze the degree of dissolution of the target sample from the at least one transmission image by using a different analysis algorithm of the at least one analysis algorithm for each patterned background image of the at least one patterned background image corresponding to the at least one transmission image.

4. The apparatus of claim 1, wherein the processor is further configured to:
analyze the degree of dissolution of the target sample from the at least one transmission image or a combination of the at least one transmission image by using a neural network trained based on the at least one analysis algorithm.

5. The apparatus of claim 1, wherein the processor is further configured to:
extract features from the at least one transmission image;
analyze the degree of dissolution of the target sample as being one of a completely dissolved state, a supersaturated state, or a turbid state based on the extracted features; and
generate a control signal based on a result of the analyzing the degree of dissolution of the target sample.

6. The apparatus of claim 5, wherein the processor is further configured to:
extract a region of interest (ROI) from the at least one transmission image; and
extract the features by applying, to the ROI, a different analysis algorithm of the at least one analysis algorithm for each patterned background image of the at least one patterned background image corresponding to the at least one transmission image.

7. The apparatus of claim 6, wherein the at least one patterned background image comprises at least one of a checker pattern image, a white image, or a radial pattern image, and
wherein the at least one analysis algorithm comprises:
a first analysis algorithm corresponding to the white image, the first analysis algorithm comprising a (1-1)-th analysis algorithm configured to analyze the degree of dissolution of the target sample based on uniformity in a grid corresponding to the ROI, a (1-2)-th analysis algorithm configured to analyze the degree of dissolution of the target sample based on a change in brightness and a change in curvature in a region corresponding to pixels of an image sensor corresponding to the ROI, and a (1-3)-th analysis algorithm configured to analyze the degree of dissolution of the target sample based on a number of particles included in the ROI; and
a second analysis algorithm corresponding to the checker patterned image, the second analysis algorithm comprising a (2-1)-th analysis algorithm configured to analyze the degree of dissolution of the target sample by an edge detected based on a gradient obtained from the ROI, a (2-2)-th analysis algorithm configured to analyze the degree of dissolution of the target sample by an attribute value of a straight line detected from a binarized image corresponding to the ROI, and a (2-3)-th analysis algorithm configured to analyze the degree of dissolution of the target sample by narrowing an interval between the ROIs and removing a background pixel.

8. The apparatus of claim 5, wherein the processor is further configured to:
based on the result of the analyzing indicating success, generate a control signal for proceeding with a reaction of a next operation; and
based on the result of the analyzing indicating failure, generate a control signal for adding a solvent, adjusting a temperature, adjusting an agitation speed, or increasing reaction time.

9. The apparatus of claim 5, wherein the processor is further configured to:
determine the at least one patterned background image based on a result of the analyzing the degree of dissolution of the target sample; and
control the display to display the determined at least one patterned background image.

10. The apparatus of claim 1, wherein the target sample comprises at least one of a solid sample or a liquid sample.

11. The apparatus of claim 1, further comprising a driver configured to fix or move the container according to a control signal from the processor,
wherein the camera is further configured to repeatedly capture the at least one transmission image over a period of time.

12. A method of measuring solubility, the method comprising:
displaying at least one patterned background image according to a control signal;
obtaining at least one transmission image formed by light from the at least one patterned background image being transmitted through a container accommodating a target sample, of which solubility is to be measured; and
analyzing a degree of dissolution of the target sample from the at least one transmission image based on at least one analysis algorithm.

13. The method of claim 12, wherein the at least one analysis algorithm is configured to determine, from the at least one transmission image, at least one of:
whether the target sample is completely dissolved,
opacity of a solution in which the target sample is dissolved,
whether undissolved particles are present in the solution in which the target sample is dissolved, or
whether residues are present around the container.

14. The method of claim 12, wherein the analyzing the degree of dissolution of the target sample comprises:
analyzing the degree of dissolution of the target sample from the at least one transmission image by using a different analysis algorithm of the at least one analysis algorithm for each patterned background image of the at least one patterned background image corresponding to the at least one transmission image.

15. The method of claim 12, wherein the analyzing the degree of dissolution of the target sample comprises:
analyzing the degree of dissolution of the target sample from the at least one transmission image or a combination of the at least one transmission image by using a neural network trained based on the at least one analysis algorithm.

16. The method of claim 14, wherein the analyzing the degree of dissolution of the target sample comprises:
extracting a region of interest (ROI) from the at least one transmission image;
extracting features by applying, to the ROI, a different analysis algorithm of the at least one analysis algorithm for each patterned background image of the at least one patterned background image corresponding to the at least one transmission image;
analyzing the degree of dissolution of the target sample as being one of a completely dissolved state, a supersaturated state, or a turbid state based on the extracted features; and
generating a control signal based on a result of the analyzing the degree of dissolution of the target sample.

17. The method of claim 16, wherein the generating the control signal comprises:
based on the result of the analyzing indicating success, generating a control signal for proceeding with a reaction of a next operation; and
based on the result of the analyzing indicating failure, generating a control signal for adding a solvent, adjusting a temperature, adjusting an agitation speed, or increasing reaction time.

18. The method of claim 12, wherein the analyzing the degree of dissolution of the target sample comprises:
determining the at least one patterned background image based on a result of the analyzing the degree of dissolution of the target sample; and
displaying the determined at least one patterned background image.

19. The method of claim 12, wherein the obtaining the at least one transmission image comprises:
fixing or moving the container according to the control signal; and
repeatedly capturing the at least one transmission image corresponding to the fixed or moved container over a period of time.

20. A non-transitory computer-readable storage medium storing instructions that, when executed by a processor, causes the processor to perform a method comprising:
displaying at least one patterned background image according to a control signal;
obtaining at least one transmission image formed by light from the at least one patterned background image being transmitted through a container accommodating a target sample, of which solubility is to be measured; and
analyzing a degree of dissolution of the target sample from the at least one transmission image based on at least one analysis algorithm.
